(19) United States
(12) Patent Application Publication
(10) Pub. No.: US 2010/0107428 A1
(43) Pub. Date: May 6, 2010

(54) WOODWORKING PLANE WITH ADJUSTABLE HANDLE

(76) Inventors: Robin C. Lee, Ottawa (CA); Brent K. Hyde, Ottawa (CA)

Correspondence Address: JOHN S. PRATT;KILPATRICK STOCKTON LLP (L3440), 1100 PEACHTREE STREET, SUITE 2800, ATLANTA, GA, 30309, US

(21) Appl. No.: 12/611,578

(22) Filed: Nov. 3, 2009

Related U.S. Application Data
(60) Provisional application No. 61/110,772, filed on Nov. 3, 2008.

(51) Int. Cl. B27G 17/02; B25G 1/06

(52) U.S. Cl. 30/489; 30/491

(57) ABSTRACT

An adjustable handle for a tool that can be pivoted “forward and backward,” or “side to side,” and locked in a desired position to facilitate use of the tool and handle, and a woodworking plane with such a handle. The plane may be a small scraping plane that, optionally, includes a camber screw for inducing a camber in the blade, or a lever cap thumb screw threaded into the plane body. The plane may also be a bench, block, shoulder, rabbet or other plane, and the handle may be configured in a wide variety of different shapes.

### RELATED APPLICATIONS

This application claims the benefit of U.S. Provisional Patent Application No. 61/110,772 filed Nov. 3, 2008, the contents of which are incorporated herein by reference.

### FIELD OF THE INVENTION

This invention relates to woodworking planes, including bench planes, block planes, and scraper planes, and, in particular, it relates to woodworking planes having adjustable handles.

### BACKGROUND OF THE INVENTION

Woodworking planes are devices that hold a blade so that it can be used on a workpiece, usually with a portion of the holder, often called the “sole,” in contact with the workpiece during use. Such holders were first made of wood, and some continue to be made at least partially of wood. Plane bodies began in the 19th century to be made of metal, and metal continues to be used, including cast iron, brass, bronze, ductile iron and other metals and alloys.

Bench planes, block planes, molding planes and many other planes utilize a blade held that has a cutting arris formed by intersecting bevels or by the intersection of a bevel with one side or face of the plane blade, and the blade “leans backward” in use, oriented to make a slicing cut with the blade positioned so that the cutting arris is the forward-most portion of the blade as the plane moves relative to and in contact with the workpiece.

Scraper planes, by contrast, use a blade typically having a cutting “hook” formed by sharpening the blade to have an arris that is then “turned” with a burnisher so that a tiny portion of the arris faces forward with the scraper blade “leaning forward” so that, in use, the forward-most portion of the blade is the blade top or end remote from the portion in contact with workpiece. As is explained and illustrated in The Complete Guide to Sharpening, Lee, Leonard (Taunton Press 1995) at page 139-40, scraper planes hold a scraper blade inclined toward the direction of travel during use. The bevel angle on a scraper plane blade is usually 45 degrees, although some are 30 degrees. (Page 139).

Larger planes typically are held and manipulated by handles, sometimes located to either side of the plane but more frequently front and back, such as a knob in the front and a handle or tote in the rear. Such handles are typically fixed in position on the plane body, and, indeed, are sometimes formed as part of the plane body. Smaller planes such as block planes may not have handles but often have knobs or protrusions or recesses to facilitate grasping, manipulating and applying force to the plane during use, often with contact between the user's palm and the knob or protrusion.

Plane handles are sometimes adjustable. Adjustable handles are typically used in planes intended to be used with both the sole and one side of the plane in contact with portions of a workpiece oriented at 90 degrees to each other. Such planes include, for example, some shoulder planes, Stanley carriage maker's rabbit plane model 10¼ and Stanley scraper plane models 85 and 87. Adjustable handles for such tools are desirable in order to facilitate manipulation and control of the plane in a variety of different situations that may involve differing access to the plane and its handles.

### SUMMARY OF THE INVENTION

One embodiment of this invention provides a woodworking plane having an adjustable handle or palm rest that can be pivoted: (1) “forward and backward,” partially around an axis transverse to the plane's longitudinal axis and parallel to the plane sole, and (2) “side to side,” partially around an axis parallel to, or roughly parallel to, the direction of plane travel.

This adjustable handle or palm rest can be utilized in a bench plane, a block plane and other types and configurations of planes.

For instance, this adjustable handle or palm rest can be utilized in a is a small scraping plane that, optionally, includes a camber screw for adjustable contact with the scraper blade adjacent to the blade cutting edge to induce camber in the blade, thereby causing a slightly deeper cut to be taken by the central region of the blade arris than at its corners.

In such a small scraping plane, it may be desirable to secure the blade to the blade bed of the plane body with a lever cap without any lever cap thumb screw or other protrusions from the front of the lever cap so that one of the user's fingers (typically the index finger) can lie comfortable against the lever cap with the finger end contacting the plane body near the front of the plane. This can be accomplished using a lever cap thumb screw passing through a threaded hole in the plane frog, through a gap or hole in the blade, or above the blade, and bearing against the rear of the lever cap near its top.

In some embodiments of this invention, the pivotable handle is secured to the plane body by a screw that passes through a hole in a leg depending from the handle, through a pivot washer having a concave or convex surface that contacts a matching convex or concave surface surrounding the hole in the leg, and into a threaded bore within a cross dowel rotably positioned within a post protruding from the plane body. This structure facilitates rotation of the handle about either or both of the transverse and generally longitudinal axes with the screw loosened and secure locking of the handle in a desired position with the screw tightened.

### BRIEF DESCRIPTION OF THE DRAWINGS

FIG. 1 is a perspective view of one embodiment of this invention, a small scraper plane.

FIG. 2 is an exploded perspective view of the plane shown in FIG. 1.

FIG. 3 is a rear view of the plane shown in FIG. 1 with the pivoting or handle or palm rest centered above the plane body.

FIG. 4 is a section view taken along line 4-4 in FIG. 3.

FIG. 5 is a side elevation of the plane shown in FIG. 1.

FIG. 6 is a rear view of the plane shown in FIG. 1 similar to FIG. 3 but with the pivoting handle/rest or handle pivoted to one side.

FIG. 7 is an enlarged detail view taken at circle 7 in FIG. 4.

### DETAILED DESCRIPTION OF THE DRAWINGS

The figures depict a small scraper plane 10 that is exemplary of the handle or palm rests and planes of this invention. Other embodiments may be larger scraper planes, scraper rabbet planes, bench planes, bench rabbet planes or a wide variety of other woodworking planes and other tools

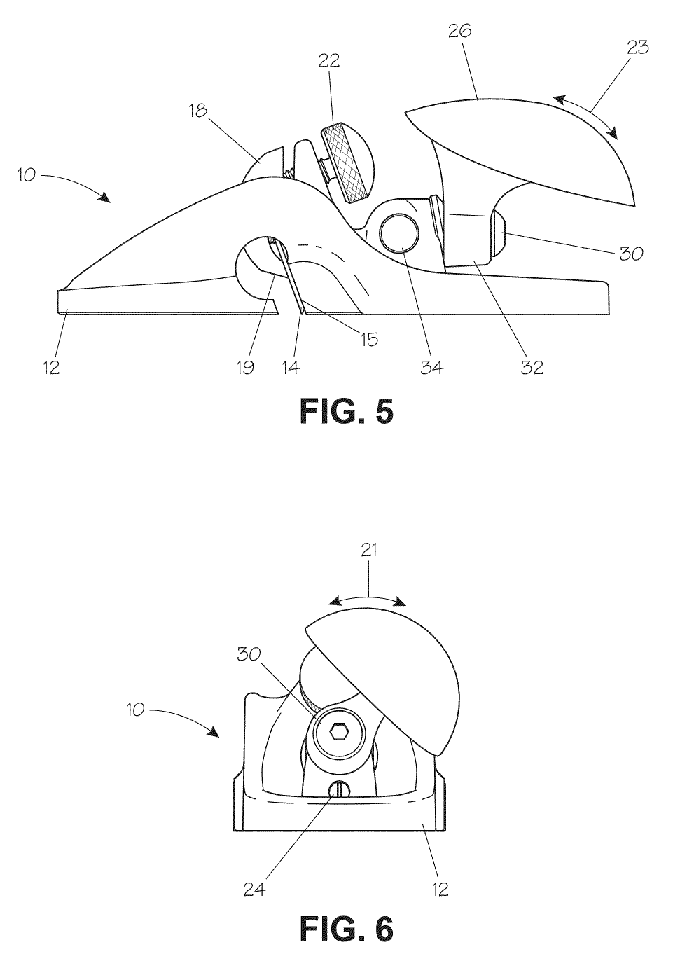

Plane 10 has a body 12 to which a blade 14 is secured with one blade face (the rear face 15) against a blade bed 16 by a lever cap 18 attached to the body 12 by a lever cap screw 20. Force is applied to the blade 14 with the lower end 19 of the lever cap 18 by pivoting the lever cap 18 with a second screw or, “lever cap thumb screw 22” having a threaded shank 31 that passes through a threaded hole 23 in the plane body 12, through a gap 25 in the blade 14 (see FIG. 2). (Gap 25 could be a hole or other opening in the blade 14, or a shorter blade 14 could be used). Lever cap thumb screw 22 bears against the rear of the lever cap 18 in a pocket 27 near its top (see FIG. 4), there by securing the blade 14 in the plane body 12 by exerting pressure with the lower end or feet 19 of lever cap 18. Unlike a typical bench plane lever cap which has a continuous “foot” that contacts the blade or a chip breaker attached to the blade across the entire width of the lever cap and applies force as near the mouth of the plane as possible, the lever cap 18 depicted in the figures contacts the blade 14 some distance from the cutting arris 17 of the blade 14, opposite the upper portion of the blade bed 16 (see, for instance, FIGS. 4 and 5). Additionally, the lower end or feet 19 of lever cap 18 contact the blade 14 not all the way across the lever cap 18 but rather only at the lever cap corners. This facilitates bowing of the blade with camber screw 24 by permitting the camber screw to push the blade slightly off of blade bed 16 and to induce a camber in the blade 14 and its cutting arris 17.

As is illustrated in the drawings, the width of the blade 14 (or the length of the cutting arris 17) and the width of the body 12 are essentially equal so that the plane is a “rabbet” or “rebate” scraper that can be effectively used to scrape a workpiece surface adjacent to an orthogonal surface or structure—in other words, it can be used in forming or refining a rabbet or rebate.

A camber screw 24 visible in FIGS. 2, 3, 4 and 6 may optionally be utilized, as is best appreciated by reference to FIG. 4, to apply force to the rear side 15 of blade 14 near the cutting arris 17. This facilitates control of projection of the blade cutting arris 17 and modestly curves the blade 14 and cutting arris 17 that protrudes slightly through the sole 13 of body 12 to keep corners of the blade from digging into the workpiece.

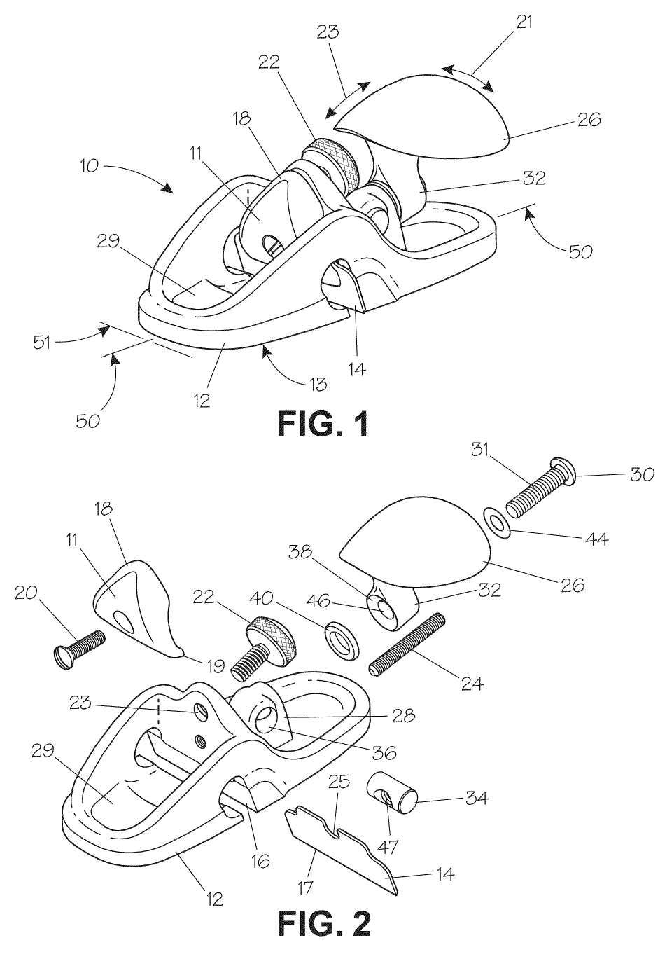

The longitudinal axis of the plane is illustrated as line 50 in FIG. 1 and is at a right angle to a transverse direction indicated by line 51 in FIG. 1.

A pivoting rear handle or palm rest 26 has a depending leg 32 that is attached to a post 28 protruding from body 12 to the rear of the blade bed 16 of body 12. Pivoting handle/rest 26 is secured by a handle screw 30 that passes through a wave washer 44, and through leg 32 and concave face 38 of leg 32. It then passes through pivot washer 40 into post 28 and is threaded into threaded hole 47 of cross dowel 34 that is positioned in bore 36 of post 28.

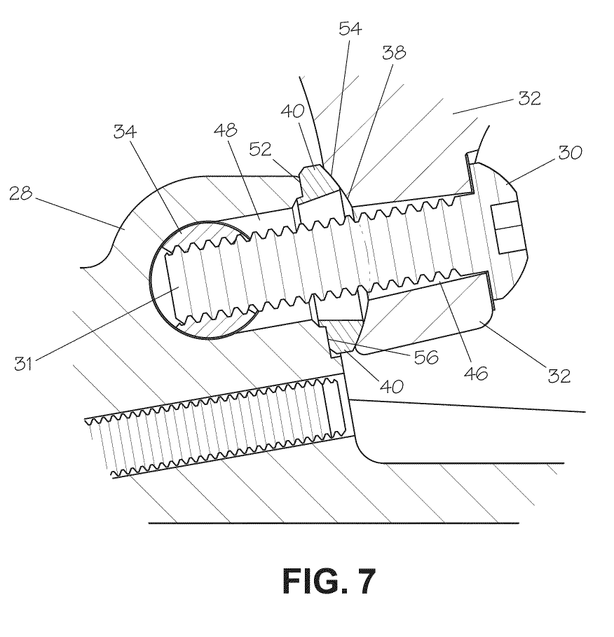

As will be appreciated by reference to FIGS. 4 and 7, pivot washer 40 has a flat face 52 that contacts post 28, and an annular convex face 54 that contacts the annular concave face 38 of post 32 surrounding hole 46 in leg 32. The hole 48 in post 28 through which handle screw 30 passes, as may be seen in FIGS. 4 and 7, is larger than the diameter of the shank 31 of screw 30. Thus, by slightly rotating cross dowel 34 within bore 36 in post 28, pivoting handle/rest 26 may pivot (as shown by arrow 23 in FIG. 1) about the axis of bore 36 in post 28. This pivoting can occur because of sliding movement of the convex face 54 of pivot washer 40 against the concave face 38 of leg 32 and the sliding movement of pivot washer 40 flat face 52 against flat face 56 of post 28.

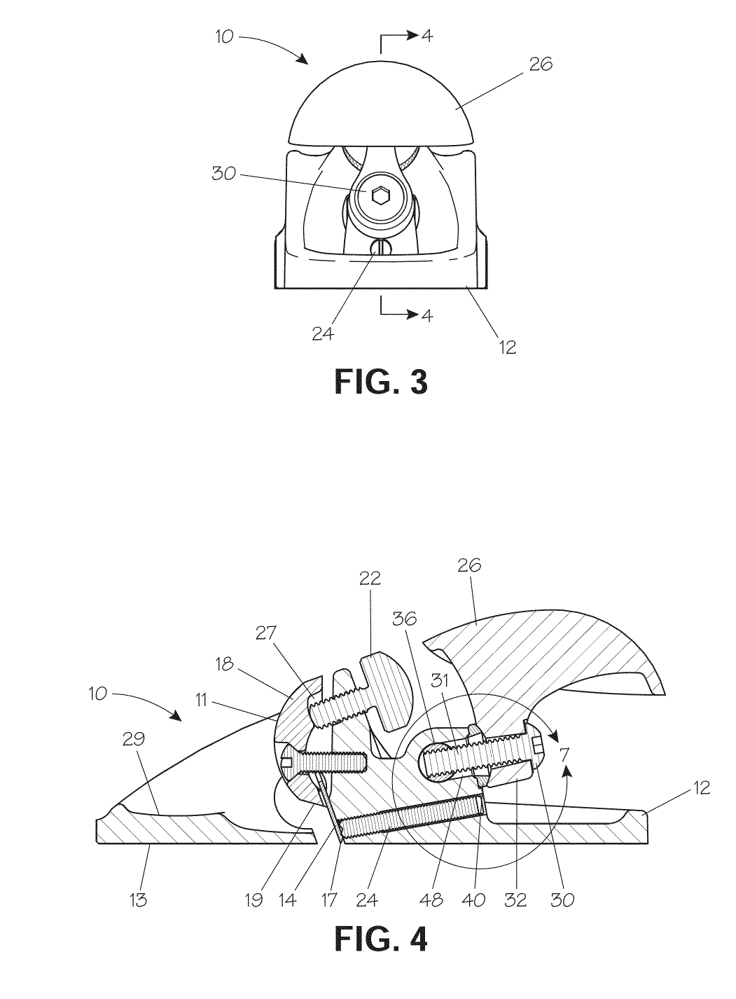

Additionally, pivoting handle/rest 26 may rotate around handle screw 30, as indicated by arrow 21 in FIG. 6 and as is illustrated by comparison of the positions of handle/rest 26 in FIGS. 3 and 6. Finally, bore 36 for cross dowel 34 and clearance between screw 30 and hole 48 in post 28 permit modest rotation of handle 36 about an axis normal to the sole 13 of plane 10. After handle/rest 26 has been pivoted and rotated into a desired position with handle screw 30 somewhat loosened, handle screw 30 may be tightened utilizing an Allen wrench or other appropriate tool so that handle/rest 26 will not move relative to body 12 during use of the plane 10.

Other structures can be used to permit both partial rotation or pivoting of the handle/rest 26 about an axis more or less parallel to the plane 10 longitudinal axis 50 shown in FIG. 1 and partial rotation of handle/rest 26 about a transverse axis 52. For instance, the pivot washer 40 could be reversed so that flat face 52 of pivot washer 40 contacts a flat face of handle/rest 26 leg 32 and a convex face 54 of washer 40 contacts a concave face of post 28. Additionally a pivot washer with one flat and one concave face could be used between a flat face on one of the post 28 or leg 32 and a convex face of the other leg 32 and post 28. Yet other structures are also possible, provided that they permit repositioning and securely fastening of pivoting handle/rest 26 (or a handle having another shape) in a variety of different positions as described above. For instance, mating convex and concave surfaces could be formed on leg 32 and post 28 for direct convert with each other without a pivot washer 40.

While the exemplary plane 10 shown in the Figures is a small scraping plane, the plane body 12 could, alternatively, have a wide range of different dimensions and configurations. The rear handle of such alternative planes can be shaped like pivoting handle/rest 26 or could have a wide variety of other shapes, including shapes like the traditional totes of traditional bench planes. Moreover, a forward handle or knob could be added fixed to the plane body in a single position or with an adjustable attachment structure similar to that described above for repositionable attachment of handle/rest 26 to plane body 12.

Blade bed 16, which is fixed in the exemplary plane 10 shown in the Figures, could be made adjustable or pivotable, as, for instance, is the case in Stanley 112 scraper plane and the Veritas scraping plane.

Alternatively, plane body 12 could be a bench plane or block plane with a blade in bevel up or bevel down configuration.

Plane body 12 may be any suitable material, including cast iron, ductile iron, manganese bronze, brass, and other suitably strong, tough, and dense composite or other materials. The other components may be made of a variety of suitable conventional materials including steel, brass and bronze.

Numerous other variations and modifications of the adjustable plane handle or rest and plane of this invention may be made without departing from the spirit and scope of the foregoing description, accompanying drawings or the following claims.

1. A woodworking plane, comprising:
(a) a plane body having a blade bed and a longitudinal axis,
(b) a handle,
(c) an annular concave surface on or secured to one of the plane body or the handle, and
(d) an annular convex surface on or secured to the other of the handle and plane body, and
(e) a threaded fastener passing through the two annular surfaces to secure the handle to the body in multiple positions.

2. The plane of claim 1, wherein the concave surface is on the handle and convex surface is formed on a washer secured between a generally planar surface of the plane body and the concave surface on the handle.

3. The plane of claim 1, wherein the handle is secured to the plane body by a screw passing through
a hole in the handle and
a washer between the handle and plane body and into a threaded screw-receiving member positioned in the plane body.

4. The plane of claim 3, wherein the threaded member comprises a cylindrical fastener penetrated by a threaded hole for receiving the screw.

5. The plane of claim 4, wherein the threaded cylinder is rotatably received in a bore in the plane body having a longitudinal bore axis transverse to the longitudinal axis of the plane.

6. The plane of claim 5, further comprising
(a) a lever cap for securing the blade in the plane body by capturing the blade between a lever cap foot and the plane body blade bed, the lever cap comprising a front surface and a back penetrated by a through hole,
(b) a first screw comprising a head and a shank passing through the hole in the lever cap and into a first threaded hole in the plane body, and
(c) a second screw passing through a second threaded hole the plane body and contacting the back of the lever cap to apply force to a top of the lever cap to urge the lever cap foot against the blade to secure the blade to the plane body.

7. The plane of claim 6 wherein the second screw contacts the lever cap in a recess, the second screw comprises a thumb screw, and the first screw head is generally flush with or recessed below the front surface of the lever cap.

8. The plane of claim 5, further comprising a blade having a cutting arris at one blade edge and a gap at the opposed plane edge through which the first screw shank may pass without contact with the blade.

9. The plane of claim 6 further comprising a finger recess in the front of the plane body within which a user's index finger may be positioned during use of the plane.

10. The plane of claim 5, wherein the body width is substantially equal to the width of the blade cutting arris.

11. A woodworking rabbet scraper plane, comprising:
(a) a plane body having a longitudinal axis, the body comprising a flat sole penetrated by a mouth, a blade bed adjacent to the mouth, a finger recess, and a post penetrated by a first hole transverse to the longitudinal axis and communicating with a second hole transverse to the first hole,
(b) a handle comprising a leg penetrated by a hole passing through an annular concave leg surface,
(c) a two-sided washer having a hole surrounded by an annular convex surface on one side and a generally planar annular surface on the other side,
(d) a cylinder penetrated laterally by a threaded hole and rotatably positioned in the first hole in the plane body post,
(e) a threaded fastener passing through the leg hole, the washer, the second hole in the plane body post and into the threaded hole in the cylinder to secure the handle to the plane body,
(f) a blade having a cutting arris substantially equal in width to the width of the blade body and a recess opposite the arris,
(g) a lever cap for securing the blade in the plane body by capturing the blade between a lever cap foot and the plane body blade bed, the lever cap comprising a front surface and a back penetrated by a through hole,
(h) a second screw comprising a head and a shank passing through the hole in the lever cap, through the blade recess and into a first threaded hole in the plane body with the second screw head substantially flush with or recessed within the front surface of the lever cap, and
(i) a third screw passing through a second threaded hole the plane body and contacting a recess in the back of the lever cap to apply force to a top of the lever cap to urge the lever cap foot against the blade to secure it to the plane body, and
(j) a camber screw positioned in a threaded third hole in the plane body for contact with the blade proximate the arris.

12. A woodworking plane, comprising:
(a) a plane body comprising a sole and having a generally longitudinal axis and a generally transverse axis and
(b) a handle secured to the body with
(c) a fastener accommodating positioning of the handle in a range of positions relative to the body pivoting around a generally longitudinal axis and, alternatively, around a generally transverse axis.

13. The plane of claim 12, wherein the handle is secured to the plane body by a screw passing through a hole in the handle, a washer between the handle and plane body and into a threaded screw-receiving member positioned in the plane body.

14. The plane of claim 13, wherein the threaded member comprises a cylindrical fastener penetrated by a threaded hole for receiving the screw.

15. The plane of claim 14, wherein the threaded cylinder is rotatably received in a bore in the plane body having a longitudinal bore axis transverse to the longitudinal axis of the plane.

16. The plane of claim 15, further comprising:
(a) a lever cap for securing the blade in the plane body by capturing the blade between a lever cap foot and the plane body blade bed, the lever cap comprising a front surface and a back penetrated by a through hole,
(b) a first screw comprising a head and a shank passing through the hole in the lever cap and into a first threaded hole in the plane body, and
(c) a second screw passing through a second threaded hole the plane body and contacting the back of the lever cap to apply force to a top of the lever cap to urge the lever cap foot against the blade to secure the blade to the plane body.

17. The plane of claim 16 wherein the second screw contacts the lever cap in a recess, the second screw comprises a thumb screw, and the first screw head is generally flush with or recessed below the front surface of the lever cap.

18. The plane of claim 17 further comprising a blade having a cutting arris at one blade edge and a gap at the opposed plane edge through which the first screw shank may pass without contact with the blade

19. The plane of claim 17 further comprising a finger recess in the front of the plane body within which a user's index finger may be positioned during use of the plane.

20. The plane of claim 12, further comprising a camber screw positioned in a threaded third hole in the plane body for contact with the blade proximate the arris to induce a camber in the arris.
